(19) United States
(12) Patent Application Publication
(10) Pub. No.: US 2024/0259934 A1
(43) Pub. Date: Aug. 1, 2024

(54) METHOD AND APPARATUS FOR SLICE AWARE CELL SELECTION AND RESELECTION IN A WIRELESS COMMUNICATION SYSTEM

(71) Applicant: LG ELECTRONICS INC., Seoul (KR)

(72) Inventors: Hyunjung CHOE, Seoul (KR); Sangwon KIM, Seoul (KR)

(73) Assignee: LG ELECTRONICS INC., Seoul (KR)

(21) Appl. No.: 18/561,269

(22) PCT Filed: Jun. 23, 2022
(86) PCT No.: PCT/KR2022/008944

§ 371 Date: Nov. 15, 2023

Related U.S. Application Data
(60) Provisional application No. 63/270,039, filed on Oct. 20, 2021.

(51) Int. Cl. H04W 48/18; H04W 36/24

(52) U.S. Cl. CPC H04W 48/18; H04W 36/24

(57) ABSTRACT

A method and apparatus for slice-aware cell selection and reselection in a wireless communication system is provided. A wireless device acquires network slice information. A wireless device acquires information on a condition for slice-aware cell reselection. A wireless device keeps performing the slice-aware cell reselection considering the network slice information, based on that the condition is met.

### CROSS-REFERENCE TO RELATED APPLICATION(S)

This application is the National Stage filing under 35 U.S.C. 371 of International Application No. PCT/KR2022/008944, filed on Jun. 23, 2022, which claims the benefit of U.S. Provisional Application No. 63/270,039, filed on Oct. 20, 2021, the contents of which are all incorporated by reference herein in their entirety.

### TECHNICAL FIELD

The present disclosure relates to a method and apparatus for slice-aware cell selection and reselection in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

In NR, the “slice info” (for a single slice or slice group) may be provided to the UE using both broadcast and dedicated signaling. The “slice info” may be provided for the serving frequency as well as neighboring frequencies.

In NR, slice-aware cell reselection may be supported. It has been discussed how long the slice-aware cell reselection is performed. For example, when the slice-aware cell reselection is performed long time, the UE may consume too much battery power. If the slice-aware cell reselection is terminated quickly and the UE cannot find a suitable cell for the highest priority slice, the UE performs legacy cell reselection procedure. However, if the UE performs legacy cell reselection, the UE may select a cell that does not support any of the intended slices of the UE.

Therefore, studies for slice-aware cell selection and reselection in a wireless communication system are required.

In an aspect, a method performed by a wireless device in a wireless communication system is provide. The method comprises, acquiring network slice information; acquiring information on a condition for slice-aware cell reselection; and keeping performing the slice-aware cell reselection considering the network slice information, based on that the condition is met.

In another aspect, an apparatus for implementing the above method is provided.

The present disclosure can have various advantageous effects.

According to some embodiments of the present disclosure, a wireless device could perform cell reselection efficiently by considering network slice.

For example, the wireless device may perform condition-based slice-aware cell reselection. Since the wireless device applies the condition to perform slice-aware cell reselection, the wireless device may save power consumption.

For example, instead of fully examining the whole frequencies list for each slice, the wireless device could find a suitable cell supporting high priority slice with flexibility.

In other words, by performing slice-based cell reselection based on conditions, there is no need to select a cell while considering the entire slice set in the wireless device. That is, the wireless device could perform slice-based cell reselection by considering the characteristics of the wireless device.

Accordingly, the time required for cell reselection and power loss can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of AMF selection to which implementations of the present disclosure is applied.

FIG. 11 shows an example of Network Slice-aware Initial Context Setup to which implementations of the present disclosure is applied.

FIG. 12 shows the states and state transitions and procedures in RRC_IDLE, except for NB-IOT, to which implementations of the present disclosure is applied.

FIG. 13 shows the states and state transitions and procedures in RRC_IDLE, for NB-IoT, to which implementations of the present disclosure is applied.

FIG. 14 shows an example of a method for slice-aware cell reselection in a wireless communication system, according to some embodiments of the present disclosure.

FIG. 15 shows an example of UE operations for condition-based slice-aware cell (re)selection.

FIG. 16 shows another example of UE operations for condition-based slice-aware cell selection and cell reselection.

FIG. 17 shows an embodiment of operations of a base station for condition-based slice-aware cell (re)selection.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

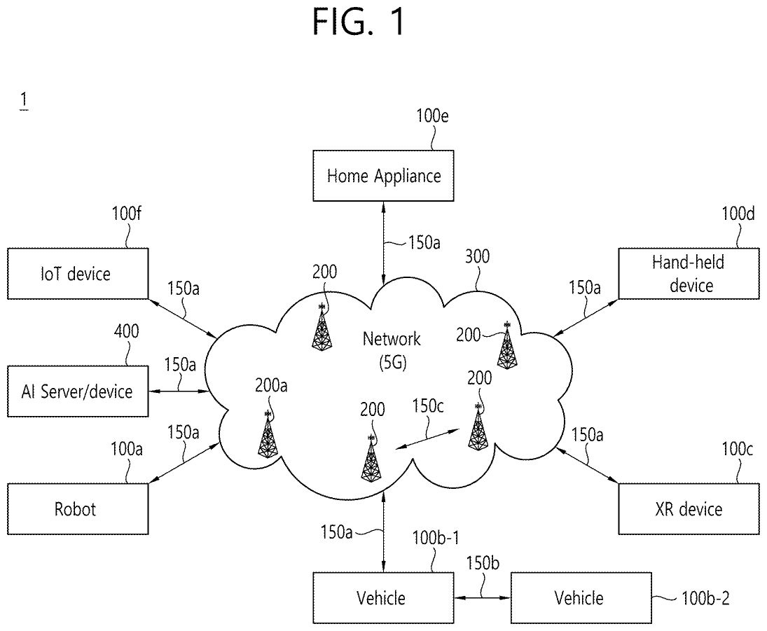

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IOT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IOT) technology for low-power communication as well as LTE, NR and 6G. For example, NB-IOT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

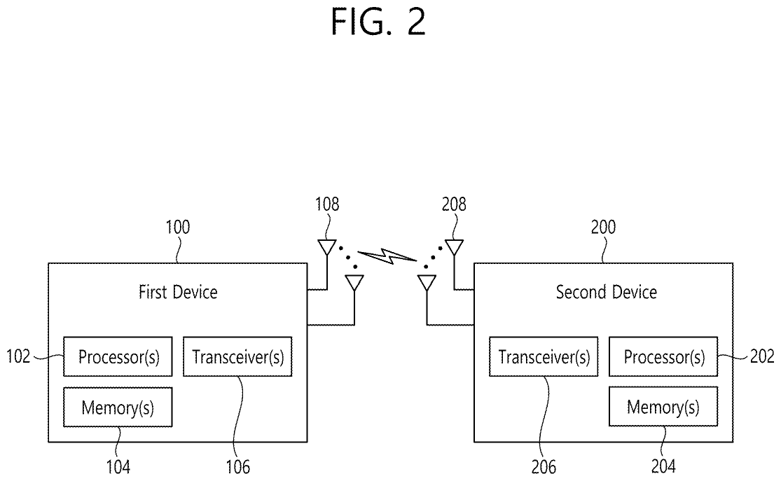

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

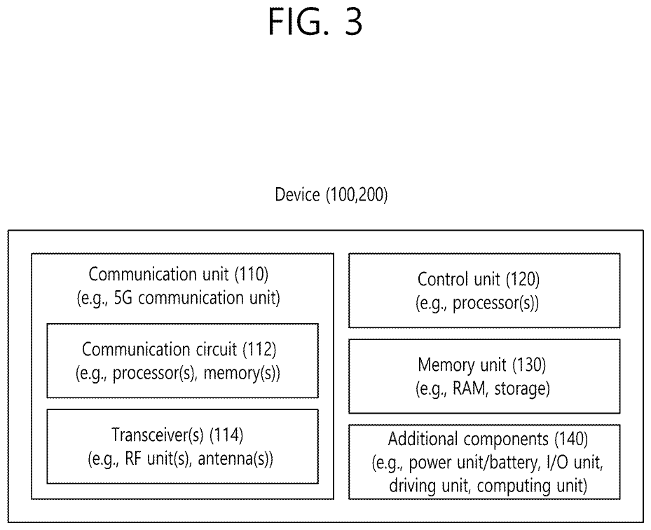

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

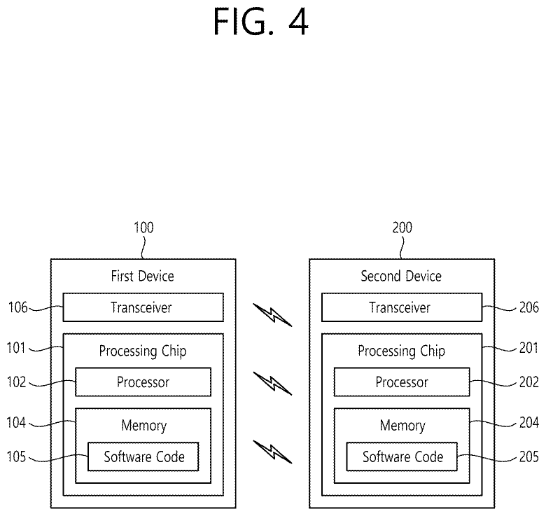

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

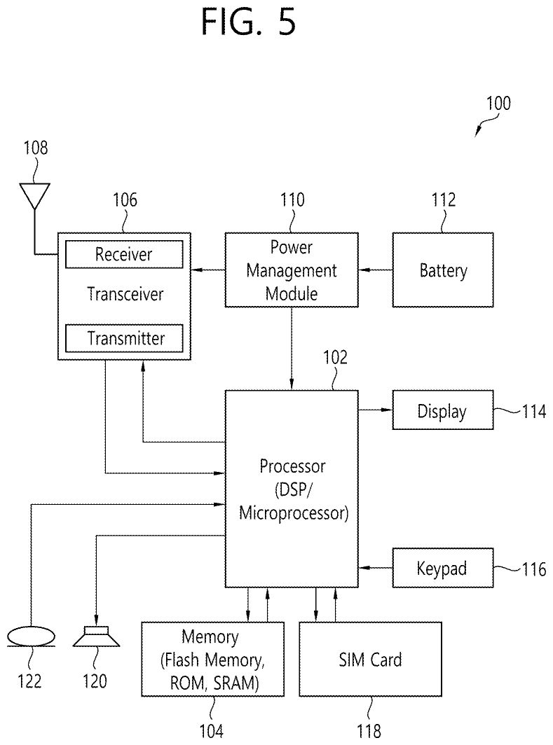

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

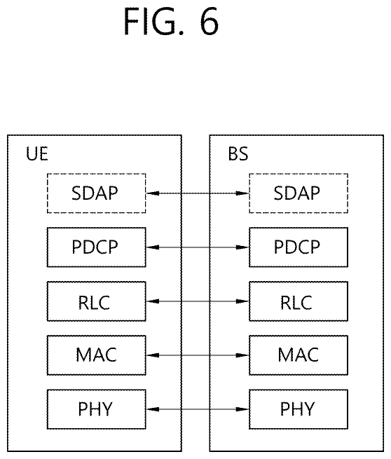

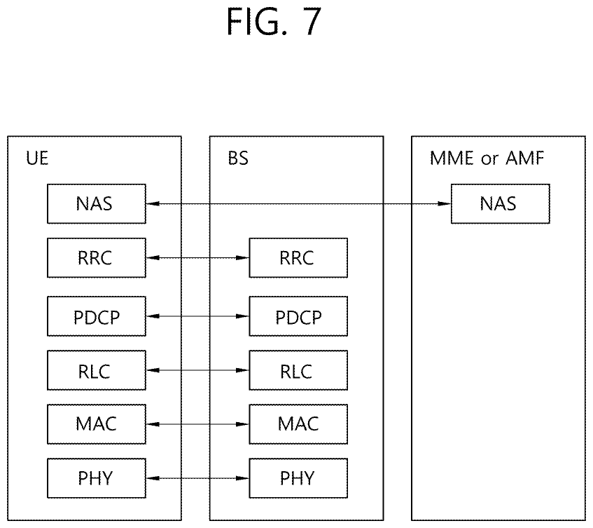

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each E logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

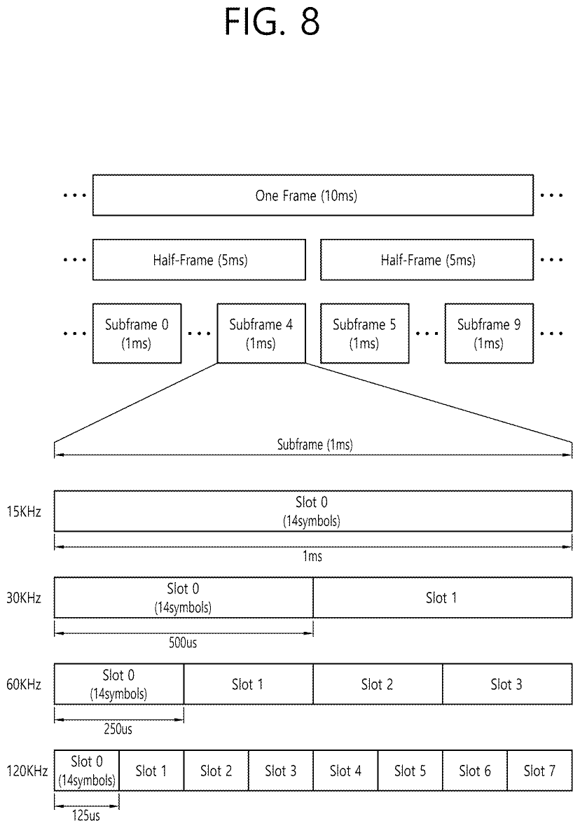

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame.u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block nCRB is as follows: n_{PRB}=N_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | Subcarrier | |
|---|---|---|---|
| designation | frequency range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHZ, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

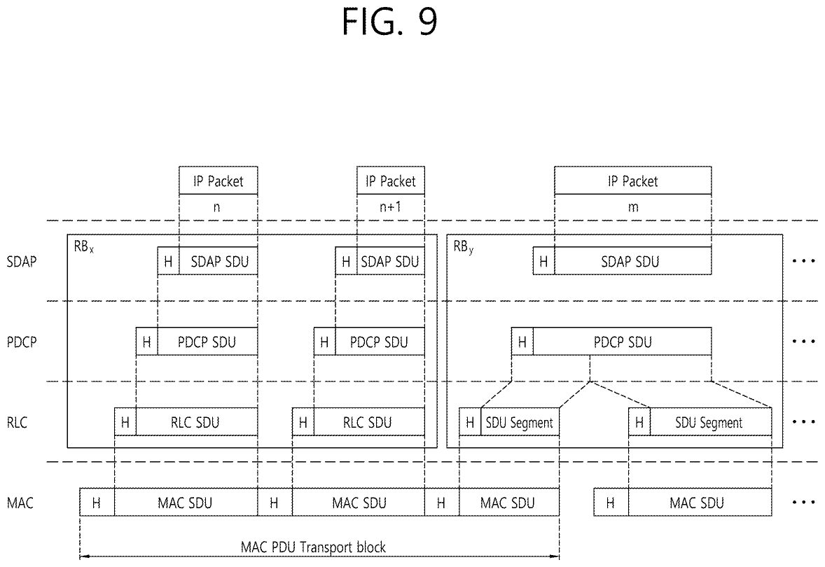

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to network slicing are described. Section 16.3 of 3GPP TS 38.300 v16.7.0 may be referred.

### General Principles and Requirements

In this clause, the general principles and requirements related to the realization of network slicing in the NG-RAN for NR connected to 5GC and for E-UTRA connected to 5GC are given.

A network slice always consists of a RAN part and a CN part. The support of network slicing relies on the principle that traffic for different slices is handled by different PDU sessions. Network can realise the different network slices by scheduling and also by providing different L1/L2 configurations.

Each network slice is uniquely identified by an S-NSSAI. NSSAI (Network Slice Selection Assistance Information) includes one or a list of S-NSSAIs (Single NSSAI) where an S-NSSAI is a combination of:
mandatory SST (Slice/Service Type) field, which identifies the slice type and consists of 8 bits (with range is 0-255);
optional SD (Slice Differentiator) field, which differentiates among Slices with same SST field and consist of 24 bits.

The list includes at most 8 S-NSSAI(s).

The UE provides NSSAI (Network Slice Selection Assistance Information) for network slice selection in RRCSetupComplete, if it has been provided by NAS. While the network can support large number of slices (hundreds), the UE need not support more than 8 slices simultaneously. A BL UE or a NB-IOT UE supports a maximum of 8 slices simultaneously.

Network Slicing is a concept to allow differentiated treatment depending on each customer requirements. With slicing, it is possible for Mobile Network Operators (MNO) to consider customers as belonging to different tenant types with each having different service requirements that govern in terms of what slice types each tenant is eligible to use based on Service Level Agreement (SLA) and subscriptions.

The following key principles apply for support of Network Slicing in NG-RAN:

### RAN Awareness of Slices

NG-RAN supports a differentiated handling of traffic for different network slices which have been pre-configured. How NG-RAN supports the slice enabling in terms of NG-RAN functions (i.e. the set of network functions that comprise each slice) is implementation dependent.

### Selection of RAN Part of the Network Slice

NG-RAN supports the selection of the RAN part of the network slice, by NSSAI provided by the UE or the 5GC which unambiguously identifies one or more of the pre-configured network slices in the PLMN.

### Resource Management Between Slices

NG-RAN supports policy enforcement between slices as per service level agreements. It should be possible for a single NG-RAN node to support multiple slices. The NG-RAN should be free to apply the best RRM policy for the SLA in place to each supported slice.

### Support of QoS

NG-RAN supports QoS differentiation within a slice.

### RAN Selection of CN Entity

For initial attach, the UE may provide NSSAI to support the selection of an AMF. If available, NG-RAN uses this information for routing the initial NAS to an AMF. If the NG-RAN is unable to select an AMF using this information or the UE does not provide any such information the NG-RAN sends the NAS signalling to one of the default AMFs.
For subsequent accesses, the UE provides a Temp ID, which is assigned to the UE by the 5GC, to enable the NG-RAN to route the NAS message to the appropriate AMF as long as the Temp ID is valid (NG-RAN is aware of and can reach the AMF which is associated with the Temp ID). Otherwise, the methods for initial attach applies.

### Resource Isolation Between Slices

The NG-RAN supports resource isolation between slices. NG-RAN resource isolation may be achieved by means of RRM policies and protection mechanisms that should avoid that shortage of shared resources in one slice breaks the service level agreement for another slice. It should be possible to fully dedicate NG-RAN resources to a certain slice. How NG-RAN supports resource isolation is implementation dependent.

### Access Control

By means of the unified access control, operator-defined access categories can be used to enable differentiated handling for different slices. NG-RAN may broadcast barring control information (i.e. a list of barring parameters associated with operator-defined access categories) to minimize the impact of congested slices.

### Slice Availability

Some slices may be available only in part of the network. The NG-RAN supported S-NSSAI(s) is configured by OAM. Awareness in the NG-RAN of the slices supported in the cells of its neighbours may be beneficial for inter-frequency mobility in connected mode. It is assumed that the slice availability does not change within the UE's registration area.
The NG-RAN and the 5GC are responsible to handle a service request for a slice that may or may not be available in a given area. Admission or rejection of access to a slice may depend by factors such as support for the slice, availability of resources, support of the requested service by NG-RAN.

### Support for UE Associating With Multiple Network Slices Simultaneously

In case a UE is associated with multiple slices simultaneously, only one signalling connection is maintained and for intra-frequency cell reselection, the UE always tries to camp on the best cell. For inter-frequency cell reselection, dedicated priorities can be used to control the frequency on which the UE camps.

### Granularity of Slice-Awareness

Slice-awareness in NG-RAN is introduced at PDU session level, by indicating the S-NSSAI corresponding to the PDU Session, in all signalling containing PDU session resource information.

### Validation of the UE Rights to Access a Network Slice

It is the responsibility of the 5GC to validate that the UE has the rights to access a network slice. Prior to receiving the Initial Context Setup Request message, the NG-RAN may be allowed to apply some provisional/local policies, based on awareness of which slice the UE is requesting access to. During the initial context setup, the NG-RAN is informed of the slice for which resources are being requested.

### AMF and NW Slice Selection

### CN-RAN Interaction and Internal RAN Aspects

NG-RAN selects AMF based on a Temp ID or NSSAI provided by the UE over RRC. The mechanisms used in the RRC protocol are described in the next clause.

Table 5 shows an example of AMF selection based on Temp ID and NSSAI.

TABLE 5

| Temp ID | NSSAI | AMF Selection by NG-RAN |
|---|---|---|
| not available | not available | One of the default AMFs is selected |
| or invalid | | (NOTE) |
| not available | present | Selects AMF which supports UE requested |
| or invalid | | slices |
| valid | not available, | Selects AMF per CN identity information |
| | or present | in Temp ID |

The set of default AMFs is configured in the NG-RAN nodes via OAM.

### Radio Interface Aspects

When triggered by the upper layer, the UE conveys the NSSAI over RRC in the format explicitly indicated by the upper layer.

### Resource Isolation and Management

Resource isolation enables specialized customization and avoids one slice affecting another slice.

Hardware/software resource isolation is up to implementation. Each slice may be assigned with either shared or dedicated radio resource up to RRM implementation and SLA.

To enable differentiated handling of traffic for network slices with different SLA:
NG-RAN is configured with a set of different configurations for different network slices by OAM;
To select the appropriate configuration for the traffic for each network slice, NG-RAN receives relevant information indicating which of the configurations applies for this specific network slice.

### AMF and NW Slice Selection

RAN selects the AMF based on a Temp ID or NSSAI provided by the UE.

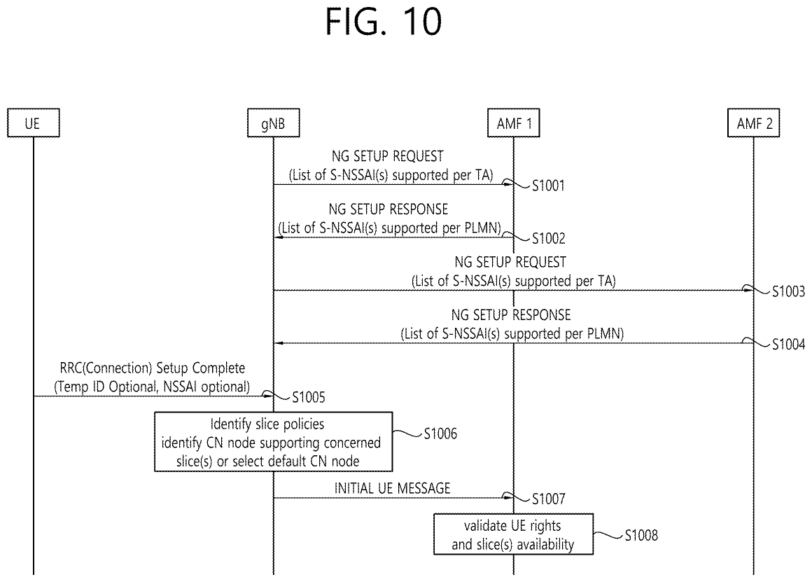

FIG. 10 shows an example of AMF selection to which implementations of the present disclosure is applied.

In case a Temp ID is not available, the NG-RAN uses the NSSAI provided by the UE at RRC connection establishment to select the appropriate AMF (the information is provided after MSG3 of the random access procedure). If such information is also not available, the NG-RAN routes the UE to one of the configured default AMF(s).

The NG-RAN uses the list of supported S-NSSAI(s) previously received in the NG Setup Response message when selecting the AMF with the NSSAI. This list may be updated via the AMF Configuration Update message.

In step S1001, gNB may transmit, to AMF1, an NG SETUP REQUEST message including list of S-NSSAI(s) supported per TA.

In step S1002, gNB may receive, from AMF1 and AMF2, an NG SETUP REQUEST including list of S-NSSAI(s) supported per PLMN.

In step S1003, gNB may transmit, to AMF2, an NG SETUP REQUEST message including list of S-NSSAI(s) supported per TA.

In step S1004, gNB may receive, from AMF2, an NG SETUP REQUEST including list of S-NSSAI(s) supported per PLMN.

In step S1005, gNB may receive, from UE, an RRC (Connection) Setup Complete message including Temp ID (optional) and NSSAI (optional).

In step S1006, gNB may identify slice policies, identify CN node supporting concerned slice(s), or select default CN node.

In step S1007, gNB may transmit, to AMF1, an INITIAL UE message.

In step S1008, gNB may validate UE rights and slice(s) availability.

UE Context Handling is described

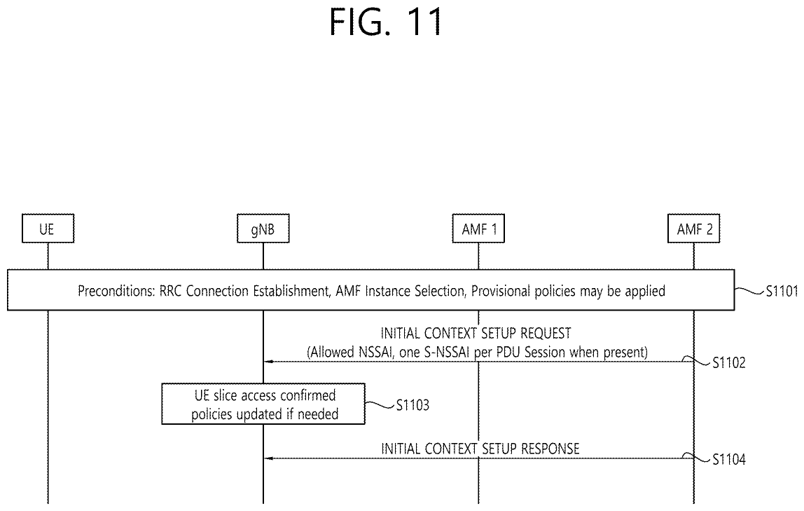

FIG. 11 shows an example of Network Slice-aware Initial Context Setup to which implementations of the present disclosure is applied.

Following the initial access, the establishment of the RRC connection and the selection of the correct AMF, the AMF establishes the complete UE context by sending the Initial Context Setup Request message to the NG-RAN over NG-C. The message contains the Allowed NSSAI and additionally contains the S-NSSAI(s) as part of the PDU session(s) resource description when present in the message. Upon successful establishment of the UE context and allocation of PDU session resources to the relevant network slice(s) when present, the NG-RAN responds with the Initial Context Setup Response message.

In step S1101, as preconditions, RRC Connection establishment, AMF Instance selection, Provisional policies may be applied.

In step S1102, AMF2 (or AMF1) may transmit, to gNB, an initial context setup request message including allowed NSSAI and/or one S-NSSAI per PDU session when present.

In step S1103, in gNB, UE slice access may be confirmed, and policies may be updated if needed.

In step S1104, gNB may transmit, to the AMF2 (or AMF1), an initial context setup response message.

Hereinafter, technical features related to cell selection and reselection are described. Section 5.2 of 3GPP TS 36.304 v16.5.0 may be referred.

UE shall perform measurements for cell selection and reselection purposes.

The NAS can control the RAT(s) in which the cell selection should be performed, for instance by indicating RAT(s) associated with the selected PLMN, and by maintaining a list of forbidden registration area(s) and a list of equivalent PLMNs. The UE shall select a suitable cell based on idle mode measurements and cell selection criteria.

In order to speed up the cell selection process, stored information for several RATs may be available in the UE.

When camped on a cell, the UE shall regularly search for a better cell according to the cell reselection criteria. If a better cell is found, that cell is selected. The change of cell may imply a change of RAT, or if the current and selected cell are both E-UTRA cells, a change of the CN type.

The NAS is informed if the cell selection and reselection results in changes in the received system information relevant for NAS.

For normal service, the UE shall camp on a suitable cell, tune to that cell's control channel(s) so that the UE can:
Receive system information from the PLMN; and
   receive registration area information from the PLMN, e.g., tracking area information; and
   receive other AS and NAS Information; and
if registered:
   receive paging and notification messages from the PLMN; and
   initiate transfer to connected mode.

States and state transitions in Idle Mode is described.

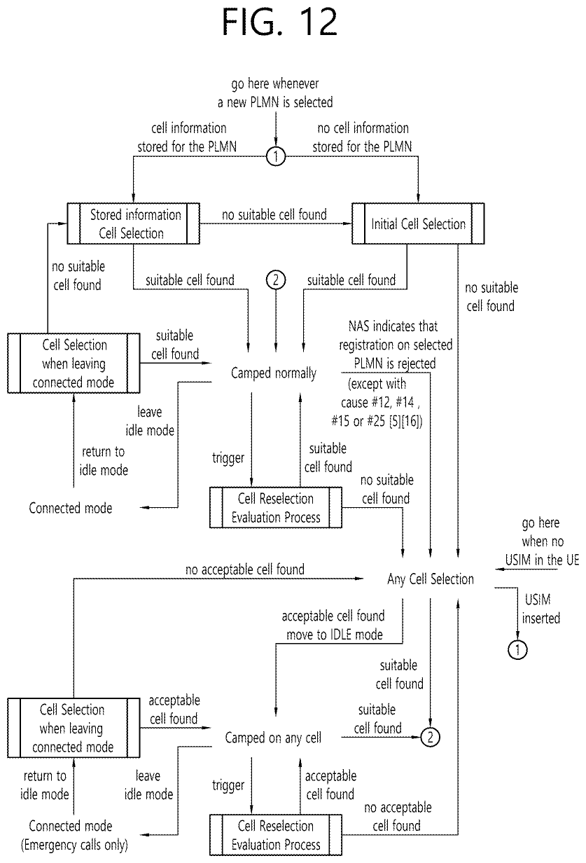

FIG. 12 shows the states and state transitions and procedures in RRC_IDLE, except for NB-IOT, to which implementations of the present disclosure is applied.

In FIG. 12, whenever a new PLMN selection is performed, it causes an exit to number 1.

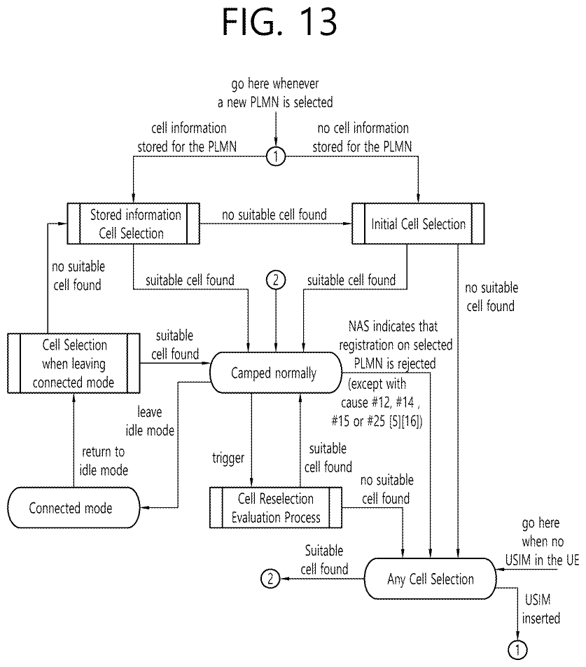

FIG. 13 shows the states and state transitions and procedures in RRC_IDLE, for NB-IoT, to which implementations of the present disclosure is applied.

In FIG. 13 whenever a new PLMN selection is performed, it causes an exit to number 1.

Cell Selection process is described.

The UE shall use one of the following two cell selection procedures:

### a) Initial Cell Selection

This procedure requires no prior knowledge of which RF channels are E-UTRA or NB-IOT carriers. The UE shall scan all RF channels in the E-UTRA bands according to its capabilities to find a suitable cell. On each carrier frequency, the UE need only search for the strongest cell. Once a suitable cell is found this cell shall be selected.

### b) Stored Information Cell Selection

This procedure requires stored information of carrier frequencies and optionally also information on cell parameters, from previously received measurement control information elements or from previously detected cells. Once the UE has found a suitable cell the UE shall select it. If no suitable cell is found the Initial Cell Selection procedure shall be started.

Priorities between different frequencies or RATs provided to the UE by system information or dedicated signalling are not used in the cell selection process.

If BL UE, UE in enhanced coverage or NB-IOT UE has been provisioned with EARFCN, the UE may use this information during Initial Cell Selection and Stored Information Cell Selection to find a suitable cell.

Cell Selection Criterion is described.

The cell selection criterion S in normal coverage is fulfilled when:

$$Srxlev > 0 AND Squal > 0$$

$$where : Srxlev = {Q}_{rxlevmeas} - ( {Q}_{rxlevmin} + {Q}_{rxlevminoffset} ) - Pcompensation - {Qoffset}_{t e m p}$$

$$Squal = {Q}_{qualmeas} - ( {Q}_{qualmin} + {Q}_{qualminoffset} ) - {Qoffset}_{t e m p}$$

Table 6 shows the variables for the cell selection criterion.

TABLE 6

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} IS |
| | present in SIB3 and SIB4 for the concerned cell, this cell specific |
| | offset is added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 and SIB4, |
| | additionally, if Q_{rxtevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signalled for the concerned cell, this cell specific offset |
| | is added to achieve the required minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority PLMN |
| | while camped normally in a VPLMN. |
| Q_{qualminoffset} | Offset to the signalled Q_{qualmin} taken into account in the Squal |
| | evaluation as a result of a periodic search for a higher priority PLMN |
| | while camped normally in a VPLMN. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| P_{EMAX1}, P_{EMAX2} | Maximum TX power level of a UE may use when transmitting on the |
| | uplink in the cell (dBm) defined as P_{EMAX}. If UE supports SUL |
| | frequency for this cell, P_{EMAX1} and P_{EMAX2} are obtained from the p-Max |
| | for SUL in SIB1 and NR-NS-PmaxList for SUL respectively in SIB1, |
| | SIB2 and SIB4, else P_{EMAX1} and P_{EMAX2} are obtained from the p-Max |
| | and NR-NS-PmaxList respectively in SIB1, SIB2 and SIB4 for normal |
| | UL. |
| P_{PowerClass} | Maximum RF output power of the UE (dBm) according to the UE |
| | power class. |

The signalled values Q_{rxlevminoffset} and Q_{qualminoffset} are only applied when a cell is evaluated for cell selection as a result of a periodic search for a higher priority PLMN while camped normally in a VPLMN. During this periodic search for higher priority PLMN, the UE may check the S criteria of a cell using parameter values stored from a different cell of this higher priority PLMN.

Hereinafter, cell reselection evaluation process is described.

Reselection priorities handling is described.

Absolute priorities of different NR frequencies or inter-RAT frequencies may be provided to the UE in the system information, in the RRCRelease message, or by inheriting from another RAT at inter-RAT cell (re)selection. In the case of system information, an NR frequency or inter-RAT frequency may be listed without providing a priority (i.e. the field cellReselectionPriority is absent for that frequency). If priorities are provided in dedicated signalling, the UE shall ignore all the priorities provided in system information. If UE is in camped on any cell state, UE shall only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE shall consider the current frequency to be the lowest priority frequency (i.e. lower than any of the network configured values). If the UE is configured to perform both NR sidelink communication and V2X sidelink communication, the UE may consider the frequency providing both NR sidelink communication configuration and V2X sidelink communication configuration to be the highest priority. If the UE is configured to perform NR sidelink communication and not perform V2X communication, the UE may consider the frequency providing NR sidelink communication configuration to be the highest priority. If the UE is configured to perform V2X sidelink communication and not perform NR sidelink communication, the UE may consider the frequency providing V2X sidelink communication configuration to be the highest priority.

The frequency only providing the anchor frequency configuration should not be prioritized for V2X service during cell reselection.

When UE is configured to perform NR sidelink communication or V2X sidelink communication performs cell reselection, it may consider the frequencies providing the intra-carrier and inter-carrier configuration have equal priority in cell reselection.

The prioritization among the frequencies which UE considers to be the highest priority frequency is left to UE implementation.

The UE is configured to perform V2X sidelink communication or NR sidelink communication, if it has the capability and is authorized for the corresponding sidelink operation.

When UE is configured to perform both NR sidelink communication and V2X sidelink communication, but cannot find a frequency which can provide both NR sidelink communication configuration and V2X sidelink communication configuration, UE may consider the frequency providing either NR sidelink communication configuration or V2X sidelink communication configuration to be the highest priority.

The UE shall only perform cell reselection evaluation for NR frequencies and inter-RAT frequencies that are given in system information and for which the UE has a priority provided.

In case UE receives RRCRelease with deprioritisationReq, UE shall consider current frequency and stored frequencies due to the previously received RRCRelease with deprioritisationReq or all the frequencies of NR to be the lowest priority frequency (i.e. lower than any of the network configured values) while T325 is running irrespective of camped RAT. The UE shall delete the stored deprioritisation request(s) when a PLMN selection or SNPN selection is performed on request by NAS.

UE should search for a higher priority layer for cell reselection as soon as possible after the change of priority. The minimum related performance requirements are still applicable.

The UE shall delete priorities provided by dedicated signalling when:
the UE enters a different RRC state; or
the optional validity time of dedicated priorities (T320) expires; or
the UE receives an RRCRelease message with the field cellReselectionPriorities absent; or
a PLMN selection or SNPN selection is performed on request by NAS.

Equal priorities between RATs are not supported.

The UE shall not consider any black listed cells as candidate for cell reselection.

The UE shall consider only the white listed cells, if configured, as candidates for cell reselection.

The UE in RRC_IDLE state shall inherit the priorities provided by dedicated signalling and the remaining validity time (i.e. T320 in NR and E-UTRA), if configured, at inter-RAT cell (re)selection.

The network may assign dedicated cell reselection priorities for frequencies not configured by system information.

Measurement rules for cell re-selection is described.

Following rules are used by the UE to limit needed measurements:
If the serving cell fulfils Srxlev>S_{intraSearchP} and Squal>S_{IntraSearchQ}, the UE may choose not to perform intra-frequency measurements.
Otherwise, the UE shall perform intra-frequency measurements.
The UE shall apply the following rules for NR inter-frequencies and inter-RAT frequencies which are indicated in system information and for which the UE has priority provided:
For a NR inter-frequency or inter-RAT frequency with a reselection priority higher than the reselection priority of the current NR frequency, the UE shall perform measurements of higher priority NR inter-frequency or inter-RAT frequencies.
For a NR inter-frequency with an equal or lower reselection priority than the reselection priority of the current NR frequency and for inter-RAT frequency with lower reselection priority than the reselection priority of the current NR frequency:
If the serving cell fulfils Srxlev>S_{nonIntraSearchP} and Squal>S_{nonIntraSearchQ}, the UE may choose not to perform measurements of NR inter-frequency cells of equal or lower priority, or inter-RAT frequency cells of lower priority;
Otherwise, the UE shall perform measurements of NR inter-frequency cells of equal or lower priority, or inter-RAT frequency cells of lower priority.
If the UE supports relaxed measurement and relaxedMeasurement is present in SIB2, the UE may further relax the needed measurements.

### Cells With Cell Reservations, Access Restrictions or Unsuitable for Normal Camping

For the highest ranked cell (including serving cell) according to cell reselection criteria, for the best cell according to absolute priority reselection criteria, the UE shall check if the access is restricted according to the rules.

If that cell and other cells have to be excluded from the candidate list, the UE shall not consider these as candidates for cell reselection. This limitation shall be removed when the highest ranked cell changes.

If the highest ranked cell or best cell according to absolute priority reselection rules is an intra-frequency or inter-frequency cell which is not suitable due to one or more of the following reasons:
this cell belongs to a PLMN which is not indicated as being equivalent to the registered PLMN, or
this cell is a CAG cell that belongs to a PLMN which is equivalent to the registered PLMN but with no CAG-ID that is present in the UE's allowed CAG list being broadcasted, or
this cell is not a CAG cell and the CAG-only indication in the UE is set, or
this cell does not belong to a SNPN that is equal to the registered or selected SNPN of the UE in SNPN access mode,

the UE shall not consider this cell and, for operation in licensed spectrum, other cells on the same frequency as candidates for reselection for a maximum of 300 seconds.

NR Inter-frequency and inter-RAT Cell Reselection criteria is described.

If threshServingLowQ is broadcast in system information and more than 1 second has elapsed since the UE camped on the current serving cell, cell reselection to a cell on a higher priority NR frequency or inter-RAT frequency than the serving frequency shall be performed if:
A cell of a higher priority NR or EUTRAN RAT/frequency fulfils Squal>Thresh_{X,HighQ} during a time interval Treselection_{RAT}

Otherwise, cell reselection to a cell on a higher priority NR frequency or inter-RAT frequency than the serving frequency shall be performed if:
A cell of a higher priority RAT/frequency fulfils Srxlev>Thresh_{X,HighP} during a time interval Treselection_{RAT}; and
More than 1 second has elapsed since the UE camped on the current serving cell.

Cell reselection to a cell on an equal priority NR frequency shall be based on ranking for intra-frequency cell reselection.

If threshServingLowQ is broadcast in system information and more than 1 second has elapsed since the UE camped on the current serving cell, cell reselection to a cell on a lower priority NR frequency or inter-RAT frequency than the serving frequency shall be performed if:
The serving cell fulfils Squal<Thresh_{Serving,LowQ} and a cell of a lower priority NR or E-UTRAN RAT/frequency fulfils Squal>Thresh_{X,LowQ} during a time interval Treselection_{RAT}.

Otherwise, cell reselection to a cell on a lower priority NR frequency or inter-RAT frequency than the serving frequency shall be performed if:
The serving cell fulfils Srxlev<Thresh_{Serving,LowP} and a cell of a lower priority RAT/frequency fulfils Srxlev>Thresh_{X,LowP} during a time interval Treselection_{RAT}; and
More than 1 second has elapsed since the UE camped on the current serving cell.

Cell reselection to a higher priority RAT/frequency shall take precedence over a lower priority RAT/frequency if multiple cells of different priorities fulfil the cell reselection criteria.

If more than one cell meets the above criteria, the UE shall reselect a cell as follows:
If the highest-priority frequency is an NR frequency, the highest ranked cell among the cells on the highest priority frequency(ies) meeting the criteria;
If the highest-priority frequency is from another RAT, the strongest cell among the cells on the highest priority frequency(ies) meeting the criteria of that RAT.

Intra-frequency and equal priority inter-frequency Cell Reselection criteria is described.

The cell-ranking criterion Rₛ for serving cell and Rn for neighbouring cells is defined by:

$${R}_{s} = {Q}_{meas , s} + {Q}_{h y s t} - {Qoffset}_{t e m p}$$

$${R}_{n} = {Q}_{m e a s , n} - Qoffset - {Qoffset}_{t e m p}$$

Table 7 shows the variables for the cell Reselection criteria.

TABLE 7

| | |
|---|---|
| Qₘₑₐₛ | RSRP measurement quantity used in cell reselections. |
| Qoffset | For intra-frequency: Equals to Qoffset_{s, n}, if Qoffset_{s, n} is |
| | valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell. |

The UE shall perform ranking of all cells that fulfil the cell selection criterion S.

The cells shall be ranked according to the R criteria specified above by deriving Q_{meas,n} and Q_{meas,s} and calculating the R values using averaged RSRP results.

If rangeToBestCell is not configured, the UE shall perform cell reselection to the highest ranked cell. If this cell is found to be not-suitable, the UE shall behave operations related to cells with cell reservations, access restrictions or unsuitable for normal camping, as below.

If rangeToBestCell is configured. then the UE shall perform cell reselection to the cell with the highest number of beams above the threshold (i.e. absThreshSS-BlocksConsolidation) among the cells whose R value is within rangeToBestCell of the R value of the highest ranked cell. If there are multiple such cells, the UE shall perform cell reselection to the highest ranked cell among them. If this cell is found to be not-suitable, the UE shall behave operations related to cells with cell reservations, access restrictions or unsuitable for normal camping, as below.

In all cases, the UE shall reselect the new cell, only if the following conditions are met:
the new cell is better than the serving cell according to the cell reselection criteria specified above during a time interval Treselection_{RAT}:
more than 1 second has elapsed since the UE camped on the current serving cell.

If rangeToBestCell is configured but absThreshSS-BlocksConsolidation is not configured on an NR frequency, the UE considers that there is one beam above the threshold for each cell on that frequency.

Any Cell Selection state is described.

This state is applicable for RRC_IDLE and RRC_INACTIVE state. In this state, the UE shall perform cell selection process to find a suitable cell. If the cell selection process fails to find a suitable cell after a complete scan of all RATs and all frequency bands supported by the UE, the UE not in SNPN Access Mode shall attempt to find an acceptable cell of any PLMN to camp on, trying all RATs that are supported by the UE and searching first for a high-quality cell.

The UE, which is not camped on any cell, shall stay in this state.

### Camped on Any Cell State

This state is only applicable for RRC_IDLE state. In this state, the UE shall perform the following tasks:
monitor Short Messages transmitted with P-RNTI over DCI;
monitor relevant System Information;
perform necessary measurements for the cell reselection evaluation procedure;
execute the cell reselection evaluation process on the following occasions/triggers:
   1) UE internal triggers, so as to meet performance;
   2) When information on the BCCH used for the cell reselection evaluation procedure has been modified.
regularly attempt to find a suitable cell trying all frequencies of all RATs that are supported by the UE. If a suitable cell is found, UE shall move to camped normally state.
if the UE supports voice services and the current cell does not support IMS emergency calls as indicated by the field ims-EmergencySupport in SIB1, the UE shall perform cell selection/reselection to an acceptable cell that supports emergency calls in any supported RAT regardless of priorities provided in system information from current cell, if no suitable cell is found.

Meanwhile, in NR, the “slice info” (for a single slice or slice group) may be provided to the UE using both broadcast and dedicated signaling. The “slice info” may be provided for the serving frequency as well as neighboring frequencies.

In NR, slice-aware cell reselection may have been discussed. For example, when cell reselection is performed according to slice priority, the selected cell may not support the slice desired by the UE. At this time, in order to find the next candidate, the slice-based cell reselection operation should be iterated. Therefore, the power consumption of the UE may increase and the cell reselection time may take a long time.

For example, the following steps are used for slice-based cell (re)selection in AS:
Step 0: NAS layer at UE provides slice information to AS layer at UE, including slice priorities.
Step 1: AS sorts slices in priority order starting with the highest priority slice.
Step 2: Select slices in priority order starting with the highest priority slice.
Step 3: For the selected slice assign priority to frequencies received from a network.
Step 4: Starting with the highest priority frequency, perform measurements (same as legacy).
Step 5: If the highest ranked cell is suitable and supports the selected slice in step 2 then camp on the cell and exit this sequence of operation. (For example, how the UE determines whether the highest ranked cell supports the selected slice could be discussed.)
Step 6: If there are remaining frequencies then go back to step 4.
Step 7: If the end of the slice list has not been reached go back to step 2.
Step 8: Perform legacy cell reselection.

In this example, it has been discussed whether Step 7 will be kept or removed.

One of the reasons to remove Step 7 is that the UE may consume too much battery power. If Step 7 is removed and the UE cannot find a suitable cell for the highest priority slice, the UE performs legacy cell reselection procedure. However, if the UE performs legacy cell reselection, the UE may select a cell that does not support any of the intended slices of the UE.

If Step 7 is kept, the UE performs slice-aware cell reselection until the slice list is reached. In this case, the UE may consume too much battery power as slice-aware cell reselection may take a longer time than legacy procedure. Also, if a cell supporting slice that is not frequently used is selected, the UE may need to find another cell if another slice is requested.

Therefore, studies for slice-aware cell selection and reselection in a wireless communication system are required.

Hereinafter, a method for slice-aware cell selection and reselection in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

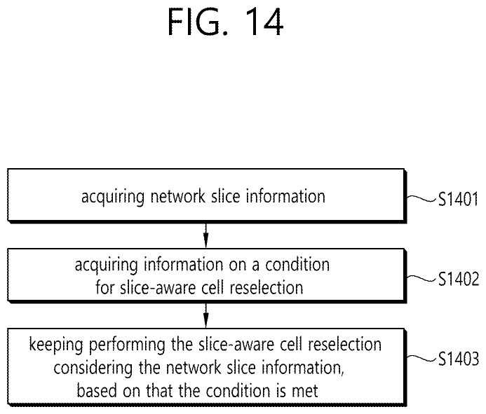

FIG. 14 shows an example of a method for slice-aware cell reselection in a wireless communication system, according to some embodiments of the present disclosure.

In particular, FIG. 14 shows an example of a method performed by a wireless device.

In step S1401, a wireless device may acquire network slice information.

For example, the network slice information may include information on a slice ID which is associated with one or more network slices.

For example, the network slice information may include information on (1) information on a specific frequency, (2) information on one or more network slices supported in the specific frequency, and (3) information on priority of the specific frequency.

For example, the wireless device may receive, from a network, the network slice information via broadcast signalling or dedicated signalling (for example, an RRC release message or a NAS registration update message).

In step S1402, a wireless device may acquire information on a condition for slice-aware cell reselection.

For example, the information on the condition may include at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

For example, the information on the condition may further include at least one of (4) information on a first time period to be used for the slice-aware cell reselection, and/or (5) information on a second time period to be consumed to find a suitable cell for a specific network slice or a specific network slice group.

For example, the wireless device may receive the condition information via dedicated RRC signalling (for example, an RRC Release message, an RRC Reconfiguration message), NAS signalling (for example, a Registration Update message), or broadcast signalling.

In step S1403, a wireless device may keep performing the slice-aware cell reselection considering the network slice information, based on that the condition is met.

The wireless device may keep performing the slice-aware cell reselection considering the network slice information, while the condition is met. That is, when the condition is not met, the wireless device may not keep performing the slice-aware cell reselection considering the network slice information.

For example, the wireless device may perform the slice-aware cell reselection considering the network slice information, for only the number of frequencies or cells included in the information on the condition. Then, the wireless device may perform cell reselection without considering the network slice information.

For example, the wireless device may perform the slice-aware cell reselection considering the network slice information, for only the number of slices or slice groups included in the information on the condition. Then, the wireless device may perform cell reselection without considering the network slice information.

For example, the wireless device may perform the slice-aware cell reselection considering the network slice information, for only the particular slice, the slice group, and/or the service type included in the information on the condition. Then, the wireless device may perform cell reselection without considering the network slice information.

For example, the wireless device may perform the slice-aware cell reselection considering the network slice information, during only the first time period included in the information on the condition. Then, the wireless device may perform cell reselection without considering the network slice information.

For example, the wireless device may perform the slice-aware cell reselection considering the network slice information, based on considering the second time period included in the information on the condition. That is, the wireless device may perform the evaluation to find a suitable cell for the specific network slice or the specific network slice group only for the second time period.

In other words, the wireless device may perform cell reselection without considering the network slice information, based on that the condition for the slice-aware cell reselection is not met.

In this case, the wireless device may exclude one or more frequencies and/or one or more cells, which had been evaluated during the slice-aware cell reselection considering the network slice information, from candidate frequencies and/or cells for the cell reselection without considering the network slice information.

According to some embodiments of the present disclosure, the wireless device may acquire information on network slice restrictions. The wireless device may determine one or more network slices intended to be used, based on the information on network slice restrictions.

For example, the wireless device may receive the information on network slice restrictions via broadcast or dedicated signalling (for example, RRC signalling and/or NAS signalling). For example, the wireless device may be configured with service restrictions information from upper layers or via dedicated signalling.

For example, the information on network slice restrictions may include information on (i) a specific area, and/or (ii) a specific time period. For example, the network slice restrictions may be depending on frequencies, area, registration of other one or more network slices, other RAT, timely manner, applications, etc.

For example, when one or more specific network slices are not available based on the information on network slice restrictions, the wireless device may determine that the one or more specific network slices are not available.

Then, when a certain frequency (or a certain cell) only supports a part of the one or more specific network slices, the wireless device may consider that the certain frequency is not available. In this case, the wireless device may exclude the certain frequency (or the certain cell) from candidate for slice-aware cell reselection.

According to some embodiments of the present disclosure, the wireless device may determine slice priority list information on priority of each network slice. For example, the wireless device may perform the slice-aware cell reselection based on the slice priority list. That is, the wireless device may evaluate a frequency (or cell) supporting a certain network slice which has the highest priority first.

For example, the wireless device may receive application information from upper layers (for example, application usage information, user membership information from the 3rd party) to determine the slice priority list. For example, the wireless device may consider network slice whose associated service has been suspended, in order to determine the slice priority list. That is, the wireless device may prioritize a certain network slice, when there is a suspended service on a certain frequency and the certain frequency supports the certain network slice. (For example, only when the certain network slice is available. If the certain network service is not available, the wireless device may deprioritize the certain network service.)

According to some embodiments of the present disclosure, the wireless device may be in communication with at least one of a user equipment, a network, or an autonomous vehicle other than the wireless device.

Hereinafter, an example of condition-based slice-aware cell (re)selection.

According to some embodiments of the present disclosure, in order to implement condition-based slice-aware cell reselection mechanism, the UE may perform slice-aware cell (re)selection, when a condition for slice-aware cell (re)selection is met.

The condition for slice-aware cell (re)selection could be:
The time period to be consumed for slice-aware cell (re)selection, or
The time period to be consumed to find a suitable cell for a particular slice or slice group, or
The number of frequencies or cells considered for slice-aware cell (re)selection, or
The number of frequencies or cells considered to find a suitable cell for a particular slice or slice group, or
The number of slices or slice groups considered for slice-aware cell (re)selection.
A particular slice, slice group, or service type (e.g. service/slice type)

For example, if the UE cannot find a suitable cell during the condition-based slice-aware cell reselection mechanism, the UE may perform a legacy cell reselection procedure.

According to some embodiments of the present disclosure, the time period/the number of frequencies/the number of slices or slice groups for the slice-aware cell (re)selection condition may be (i) configured by the network, (ii) determined by UE (for example, at least one of upper layers of the UE), or (iii) preconfigured.

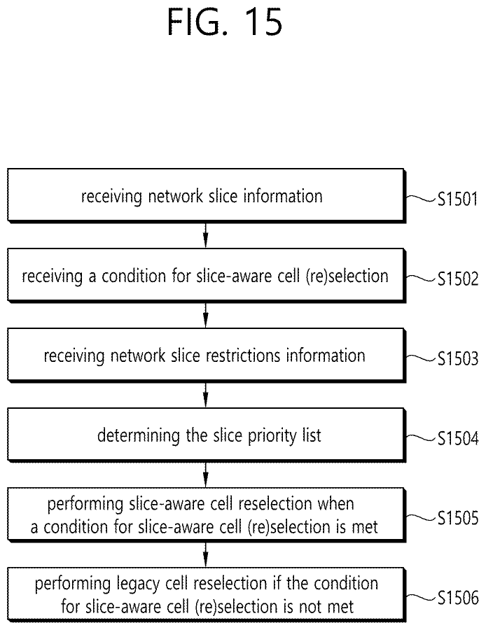

FIG. 15 shows an example of UE operations for condition-based slice-aware cell (re)selection.

In step S1501, the UE may receive network slice information.

For example, the network slice information may include a slice ID which is associated with one or more network slices.

For example, the network slice information may include a frequency and one or more network slices supported in the frequency and the frequency priority.

For example, the UE may receive network slice information via broadcast or dedicated signalling (for example, RRC release or NAS Registration update).

For example, the UE may receive slice priority information via broadcast or dedicated signalling (for example, RRC release or NAS Registration update).

For example, slice priority may be determined by UE with or without network side information.

In step S1502, the UE may receive a condition for slice-aware cell (re)selection.

The condition information may be:
the time period to be used for slice-aware cell (re)selection, or
the time period to be used to find a suitable cell for a particular slice or slice group, or
the number of frequencies considered for slice-aware cell (re)selection, or
the number of frequencies considered to find a suitable cell for a particular slice or slice group, or
the number of slices or slice groups considered for slice-aware cell (re)selection.

For example, the UE may receive the condition information via dedicated RRC signalling (for example, RRC Release or RRC Reconfiguration), NAS signalling (for example, Registration Update), or broadcast.

For example, the UE may determine the condition information based on upper layer information.

For example, the condition for slice-aware cell (re)selection may be preconfigured.

In step S1503, the UE may receive network slice restrictions information.

For example, the UE may receive network slice restrictions information via broadcast or dedicated signalling (for example. RRC signalling or NAS signalling).

For example, the UE may be configured with service restrictions information from upper layers or via dedicated signalling.

For example, the UE may receive the application restrictions information that a particular application is allowed to be used in a particular area.

For example, the network slice restrictions may be depending on frequencies, area (for example, geographical area or tracking area, cell), registration of other one or more network slices, other RAT, timely manner, applications, etc.

For example, the area information may be area ID, the associated frequency, cell ID, coordination, or information based on UE's location/positioning function.

In step S1504, the UE may determine the slice priority list.

For example, the UE may receive application information from upper layers (for example, application usage information, user membership information from the 3rd party) to determine slice priority.

For example, the UE may consider a slice whose associated service has been suspended (for example, in RRC_INACTIVE).

In step S1505, the UE may perform slice-aware cell reselection when a condition for slice-aware cell (re)selection is met.

If the UE has the time period to be used for slice-aware cell (re)selection, the UE may perform slice-aware cell reselection procedure until the timer is expired.

If the timer to be used for slice-aware cell (re)selection or to be consumed to find a suitable cell for a particular slice or slice group is expired and the UE is evaluating or verifying a cell, the UE may complete the procedure after the access verification for the cell completes.

If the UE has the number of frequencies considered for slice-aware cell (re)selection (for example, 16), the UE may perform cell reselection for slice #x, slice #y, and slice #z where the number of frequencies supporting each slice is 8, 4, 4, respectively.

That is, the condition may include the number of slices or slice groups considered for slice-aware cell (re)selection.

In step S1506, the UE may perform legacy cell reselection if the condition for slice-aware cell (re)selection is not met.

For example, the UE may exclude frequencies or cells already evaluated in Step 1505.

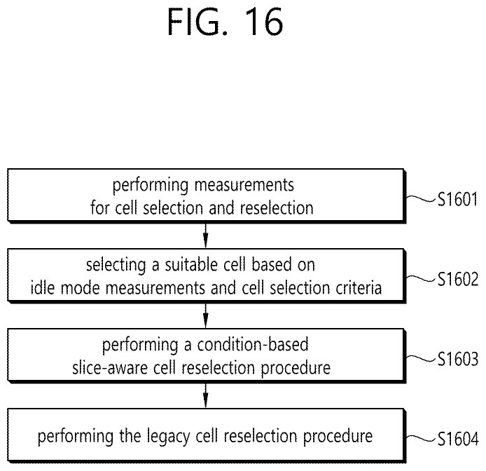

FIG. 16 shows another example of UE operations for condition-based slice-aware cell selection and cell reselection.

In step S1601, the UE may perform measurements for cell selection and reselection.

For example, the NAS can control the RAT(s) in which the cell selection should be performed, for instance by indicating RAT(s) associated with the selected PLMN, and by maintaining a list of forbidden registration area(s) and a list of equivalent PLMNs.

In step S1602, the UE may select a suitable cell based on idle mode measurements and cell selection criteria.

In order to speed up the cell selection process, stored information for several RATs may be available in the UE.

In step S1603, the UE may perform a condition-based slice-aware cell reselection procedure.

For example, when camped on a cell, the UE may search for a better cell, which supports the network slice intended to be used by the UE, while at least one condition for slice-aware cell reselection is met.

The at least one condition may be related to at least one of (1) the time period to be consumed for slice-aware cell (re)selection, (2) the time period to be consumed to find a suitable cell for a particular slice or slice group, (3) the number of frequencies or cells considered for slice-aware cell (re)selection, (4) the number of frequencies or cells considered to find a suitable cell for a particular slice or slice group, (5) the number of slices or slice groups considered for slice-aware cell (re)selection, and/or (6) a particular slice, slice group or service type (e.g. service/slice type).

That is, the UE may keep performing the slice-aware cell reselection considering the network slice information, based on that the at least one condition is met.

For example, the UE may acquire (i) network slice information, (ii) information on a condition for slice-aware cell reselection, and/or (ii) network slice restrictions information, before performing the condition-based slice-aware cell reselection procedure.

For example, the UE may determine the slice priority list, before performing the condition-based slice-aware cell reselection procedure.

For example, the UE may perform cell reselection evaluation for the condition-based slice-aware cell reselection procedure, based on the determined slice priority list.

For example, the UE may perform measurements according to measurement rules for cell re-selection, in order to perform the cell reselection evaluation.

If a better cell, which supports the network slice intended to be used by the UE, is found, that cell may be selected for the cell reselection procedure. That is, the UE may camp on the better cell.

However, if a better cell is not found, while the at least one condition for slice-aware cell reselection is met, the UE may perform the legacy cell reselection procedure, as in step S1604 below.

In step S1604, the UE may perform the legacy cell reselection procedure.

For example, the UE may exclude frequencies or cells already evaluated for the condition-based slice-aware cell reselection procedure in the step S1603.

For example, the UE may perform the intra-frequency, inter-frequency, and/or inter-RAT Cell Reselection procedure.

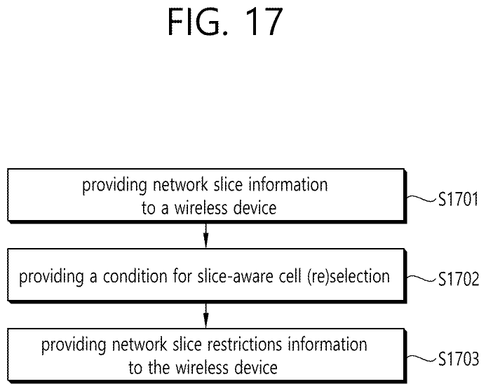

FIG. 17 shows an embodiment of operations of a base station for condition-based slice-aware cell (re)selection.

In step S1701, the base station may provide network slice information to a wireless device.

For example, the base station (for example, a cell) may provide the network slice information via broadcast or dedicated signalling (for example, RRC release and/or NAS Registration update).

For example, the base station (for example, a cell) may provide slice priority information via broadcast or dedicated signalling (for example, RRC release and/or NAS Registration update).

In step S1702, the base station may provide a condition for slice-aware cell (re)selection.

For example, the base station may provide the condition information via dedicated RRC signalling (for example, RRC Release and/or RRC Reconfiguration), NAS signalling (for example, Registration Update), and/or broadcast signalling.

In step S1703, the base station may provide network slice restrictions information to the wireless device.

For example, the base station may provide the network slice restrictions information via broadcast or dedicated signalling (for example, RRC signalling and/or NAS signalling).

The network slice restrictions may be depending on frequencies, area (for example, geographical area, tracking area, cell), registration of other one or more network slices, other RAT, timely manner, applications, etc.

Some of the detailed steps shown in the examples of FIGS. 14, 15, 16, and 17 may not be essential steps and may be omitted. In addition to the steps shown in FIGS. 14, 15, 16, and 17, other steps may be added, and the order of the steps may vary. Some of the above steps may have their own technical meaning.

Hereinafter, an apparatus for slice-aware reselection in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to acquire network slice information. The processor 102 may be configured to acquire information on a condition for slice-aware cell reselection. The processor 102 may be configured to keep performing the slice-aware cell reselection considering the network slice information, based on that the condition is met. The information on the condition may include at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

For example, the processor 102 may be configured to perform cell reselection without considering the network slice information, based on that the condition for the slice-aware cell reselection is not met. For example, the processor 102 may be configured to exclude one or more frequencies and/or one or more cells, which had been evaluated during the slice-aware cell reselection considering the network slice information, from candidate frequencies and/or cells for the cell reselection without considering the network slice information.

For example, the information on the condition may further include at least one of (4) information on a first time period to be used for the slice-aware cell reselection, and/or (5) information on a second time period to be consumed to find a suitable cell for a specific network slice or a specific network slice group.

For example, the network slice information may include information on a slice ID which is associated with one or more network slices.

For example, the network slice information may include information on (1) information on a specific frequency, (2) information on one or more network slices supported in the specific frequency, and (3) information on priority of the specific frequency.

For example, the processor 102 may be configured to acquire information on network slice restrictions. The processor 102 may be configured to determine one or more network slices intended to be used, based on the information on network slice restrictions.

For example, the information on network slice restrictions may include information on (i) a specific area, and/or (ii) a specific time period.

For example, the processor 102 may be configured to determine slice priority list information on priority of each network slice. For example, the slice-aware cell reselection may be performed based on the slice priority list.

For example, the processor 102 may be configured to control the transceiver 106 to receive, from a network, the network slice information via broadcast or dedicated signalling.

For example, the processor 102 may be configured to control the transceiver 106 to receive, from a network, the information on the condition for slice-aware cell reselection via a Radio Resource Control (RRC) Release message, an RRC Reconfiguration message, and/or a Registration Update message.

According to some embodiments of the present disclosure, the processor 102 may be configured to be in communication with at least one of a user equipment, a network, or an autonomous vehicle other than the wireless device.

Hereinafter, a processor for a wireless device for slice-aware reselection in a wireless communication system, according to some embodiments of the present disclosure, will be described.

The processor may be configured to control the wireless device to acquire network slice information. The processor may be configured to control the wireless device to acquire information on a condition for slice-aware cell reselection. The processor may be configured to control the wireless device to keep performing the slice-aware cell reselection considering the network slice information, based on that the condition is met. The information on the condition may include at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

For example, the processor may be configured to control the wireless device to perform cell reselection without considering the network slice information, based on that the condition for the slice-aware cell reselection is not met. For example, the processor may be configured to control the wireless device to exclude one or more frequencies and/or one or more cells, which had been evaluated during the slice-aware cell reselection considering the network slice information, from candidate frequencies and/or cells for the cell reselection without considering the network slice information.

For example, the information on the condition may further include at least one of (4) information on a first time period to be used for the slice-aware cell reselection, and/or (5) information on a second time period to be consumed to find a suitable cell for a specific network slice or a specific network slice group.

For example, the network slice information may include information on a slice ID which is associated with one or more network slices.

For example, the network slice information may include information on (1) information on a specific frequency, (2) information on one or more network slices supported in the specific frequency, and (3) information on priority of the specific frequency.

For example, the processor may be configured to control the wireless device to acquire information on network slice restrictions. The processor may be configured to control the wireless device to determine one or more network slices intended to be used, based on the information on network slice restrictions.

For example, the information on network slice restrictions may include information on (i) a specific area, and/or (ii) a specific time period.

For example, the processor may be configured to control the wireless device to determine slice priority list information on priority of each network slice. For example, the slice-aware cell reselection may be performed based on the slice priority list.

For example, the processor may be configured to control the wireless device to receive, from a network, the network slice information via broadcast or dedicated signalling.

For example, the processor may be configured to control the wireless device to receive, from a network, the information on the condition for slice-aware cell reselection via a Radio Resource Control (RRC) Release message, an RRC Reconfiguration message, and/or a Registration Update message.

According to some embodiments of the present disclosure, the processor may be configured to control the wireless device to be in communication with at least one of a user equipment, a network, or an autonomous vehicle other than the wireless device.

Hereinafter, a non-transitory computer-readable medium has stored thereon a plurality of instructions for slice-aware cell reselection in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to acquire network slice information. The stored a plurality of instructions may cause the wireless device to acquire information on a condition for slice-aware cell reselection. The stored a plurality of instructions may cause the wireless device to keep performing the slice-aware cell reselection considering the network slice information, based on that the condition is met. The information on the condition may include at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

For example, the stored a plurality of instructions may cause the wireless device to perform cell reselection without considering the network slice information, based on that the condition for the slice-aware cell reselection is not met. For example, the stored a plurality of instructions may cause the wireless device to exclude one or more frequencies and/or one or more cells, which had been evaluated during the slice-aware cell reselection considering the network slice information, from candidate frequencies and/or cells for the cell reselection without considering the network slice information.

For example, the information on the condition may further include at least one of (4) information on a first time period to be used for the slice-aware cell reselection, and/or (5) information on a second time period to be consumed to find a suitable cell for a specific network slice or a specific network slice group.

For example, the network slice information may include information on a slice ID which is associated with one or more network slices.

For example, the network slice information may include information on (1) information on a specific frequency, (2) information on one or more network slices supported in the specific frequency, and (3) information on priority of the specific frequency.

For example, the stored a plurality of instructions may cause the wireless device to acquire information on network slice restrictions. The stored a plurality of instructions may cause the wireless device to determine one or more network slices intended to be used, based on the information on network slice restrictions.

For example, the information on network slice restrictions may include information on (i) a specific area, and/or (ii) a specific time period.

For example, the stored a plurality of instructions may cause the wireless device to determine slice priority list information on priority of each network slice. For example, the slice-aware cell reselection may be performed based on the slice priority list.

For example, the stored a plurality of instructions may cause the wireless device to receive, from a network, the network slice information via broadcast or dedicated signalling.

For example, the stored a plurality of instructions may cause the wireless device to receive, from a network, the information on the condition for slice-aware cell reselection via a Radio Resource Control (RRC) Release message, an RRC Reconfiguration message, and/or a Registration Update message.

According to some embodiments of the present disclosure, the stored a plurality of instructions may cause the wireless device to be in communication with at least one of a user equipment, a network, or an autonomous vehicle other than the wireless device.

Hereinafter, a base station (BS) for slice-aware cell reselection, according to some embodiments of the present disclosure, will be described.

The BS may include a transceiver, a memory, and a processor operatively coupled to the transceiver and the memory.

The processor may be configured to control the transceiver to provide, to a wireless device, network slice information. The processor may be configured to control the transceiver to provide, to the wireless device, a condition for slice-aware cell reselection. The processor may be configured to control the transceiver to provide, to the wireless device, network slice restrictions information.

The present disclosure can have various advantageous effects.

According to some embodiments of the present disclosure, a wireless device could perform cell reselection efficiently by considering network slice.

For example, the wireless device may perform condition-based slice-aware cell reselection. Since the wireless device applies the condition to perform slice-aware cell reselection, the wireless device may save power consumption.

For example, instead of fully examining the whole frequencies list for each slice, the wireless device could find a suitable cell supporting high priority slice with flexibility.

In other words, by performing slice-based cell reselection based on conditions, there is no need to select a cell while considering the entire slice set in the wireless device. That is, the wireless device could perform slice-based cell reselection by considering the characteristics of the wireless device.

Accordingly, the time required for cell reselection and power loss can be reduced.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a wireless device in a wireless communication system, the method comprising, acquiring network slice information;
acquiring information on a condition for slice-aware cell reselection; and
keeping performing the slice-aware cell reselection considering the network slice information, based on that the condition is met,
wherein the information on the condition includes at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

2. The method of claim 1, wherein the method further comprises,
performing cell reselection without considering the network slice information, based on that the condition for the slice-aware cell reselection is not met.

3. The method of claim 2, wherein the method further comprises,
excluding one or more frequencies and/or one or more cells, which had been evaluated during the slice-aware cell reselection considering the network slice information, from candidate frequencies and/or cells for the cell reselection without considering the network slice information.

4. The method of claim 1,
wherein the information on the condition further includes at least one of (4) information on a first time period to be used for the slice-aware cell reselection, and/or (5) information on a second time period to be consumed to find a suitable cell for a specific network slice or a specific network slice group.

5. The method of claim 1,
wherein the network slice information includes information on a slice ID which is associated with one or more network slices.

6. The method of claim 1,
wherein the network slice information includes information on (1) information on a specific frequency, (2) information on one or more network slices supported in the specific frequency, and (3) information on priority of the specific frequency.

7. The method of claim 1, wherein the method further comprises, acquiring information on network slice restrictions; and
determining one or more network slices intended to be used, based on the information on network slice restrictions.

8. The method of claim 7,
wherein the information on network slice restrictions includes information on (i) a specific area, and/or (ii) a specific time period.

9. The method of claim 1, wherein the method further comprises,
determining slice priority list information on priority of each network slice.

10. The method of claim 9,
wherein the slice-aware cell reselection is performed based on the slice priority list.

11. The method of claim 1, wherein the method further comprises,
receiving, from a network, the network slice information via broadcast or dedicated signalling.

12. The method of claim 1, wherein the method further comprises,
receiving, from a network, the information on the condition for slice-aware cell reselection via a Radio Resource Control (RRC) Release message, an RRC Reconfiguration message, and/or a Registration Update message.

13. The method of claim 1, wherein the wireless device is in communication with at least one of a user equipment, a network, or an autonomous vehicle other than the wireless device.

14. A wireless device in a wireless communication system comprising:
a transceiver;
a memory; and
at least one processor operatively coupled to the transceiver and the memory, and configured to:
acquire network slice information;
acquire information on a condition for slice-aware cell reselection; and
keep performing the slice-aware cell reselection considering the network slice information, based on that the condition is met,
wherein the information on the condition includes at least one of (1) information on a number of frequencies or cells on which the slice-aware cell reselection is performed, (2) information on a number of slices or slice groups on which the slice-aware cell reselection is performed, and/or (3) information on a particular slice, a slice group, and/or a service type for which the slice-aware cell reselection is performed.

15. The wireless device of claim 14, wherein the at least one processor is further configured to,
perform cell reselection without considering the network slice information, based on that the condition for the slice-aware cell reselection is not met.

16. The wireless device of claim 15, wherein the at least one processor is further configured to,
exclude one or more frequencies and/or one or more cells, which had been evaluated during the slice-aware cell reselection considering the network slice information, from candidate frequencies and/or cells for the cell reselection without considering the network slice information.

17. The wireless device of claim 14,
wherein the information on the condition further includes at least one of (4) information on a first time period to be used for the slice-aware cell reselection, and/or (5) information on a second time period to be consumed to find a suitable cell for a specific network slice or a specific network slice group.

18. The wireless device of claim 14,
wherein the network slice information includes information on a slice ID which is associated with one or more network slices.

19. The wireless device of claim 14,
wherein the network slice information includes information on (1) information on a specific frequency, (2) information on one or more network slices supported in the specific frequency, and (3) information on priority of the specific frequency.

20-29. (canceled)

30. A base station in a wireless communication system comprising:
a transceiver;
a memory; and
a processor operatively coupled to the transceiver and the memory, and configured to:
control the transceiver to provide, to a wireless device, network slice information; and
control the transceiver to provide, to the wireless device, a condition for slice-aware cell reselection; and
control the transceiver to provide, to the wireless device, network slice restrictions information.
